(19) United States
(12) Patent Application Publication
(10) Pub. No.: US 2022/0075630 A1
(43) Pub. Date: Mar. 10, 2022

(54) NON-TRANSITORY RECORDING MEDIUM, INFORMATION PROCESSING DEVICE, AND INFORMATION PROCESSING SYSTEM

(71) Applicants: Tatsuroh SUGIOKA, Kanagawa (JP); Takeshi KOYAMA, Saitama (JP); Atsushi TAKAGI, Kanagawa (JP)

(72) Inventors: Tatsuroh SUGIOKA, Kanagawa (JP); Takeshi KOYAMA, Saitama (JP); Atsushi TAKAGI, Kanagawa (JP)

(73) Assignee: Ricoh Company, Ltd.

(21) Appl. No.: 17/378,784

(22) Filed: Jul. 19, 2021

(30) Foreign Application Priority Data
Sep. 8, 2020 (JP) 2020-150350

(51) Int. Cl. G06F 9/445; G06F 13/10

(52) U.S. Cl. CPC G06F 9/44505; G06F 13/102

(57) ABSTRACT

A non-transitory recording medium storing a plurality of instructions which, when executed by one or more processors, causes the processors to perform a method. The method includes acquiring information on operation of one or more peripheral devices connectable to an information processing device and causing a peripheral device being connected to the information processing device to operate according to the information on the operation of the one or more peripheral devices.

### CROSS-REFERENCE TO RELATED APPLICATION

This patent application is based on and claims priority pursuant to 35 U.S.C. § 119(a) to Japanese Patent Application No. 2020-150350, filed on Sep. 8, 2020, in the Japan Patent Office, the entire disclosure of which is hereby incorporated by reference.

### BACKGROUND

### Technical Field

Embodiments of the present disclosure relate to a non-transitory recording medium, an information processing device, and an information processing system.

### Related Art

In general, various peripheral devices are connected to an information processing device, or an information processing apparatus, such as a personal computer or a Multi-Function Peripheral/Printer/Product (MFP). An application program installed on the information processing device provides various functions with various performances, qualities, and the like in cooperation with the peripheral device. With regard to such peripheral devices, when a Universal Serial Bus (USB) device is connected to an MFP, whether the USB device is available (usable) is determined based on a vendor ID and a product ID of the USB device.

### SUMMARY

An exemplary embodiment of the present disclosure includes a non-transitory recording medium storing a plurality of instructions which, when executed by one or more processors, causes the processors to perform a method. The method includes acquiring information on operation of one or more peripheral devices connectable to an information processing device and causing a peripheral device being connected to the information processing device to operate according to the information on the operation of the one or more peripheral devices.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an overview of an information processing system according to one or more embodiments of the disclosure;

FIG. 2 is a diagram illustrating how a communication in a video conference is established according to one or more embodiments of the disclosure;

FIG. 3 is a diagram illustrating a configuration of an information processing device and peripheral devices according to one or more embodiments of the disclosure;

FIG. 4 is a block diagram illustrating a hardware configuration of an information processing device according to one or more embodiments of the disclosure;

FIG. 5 is a block diagram illustrating a functional configuration of an information processing system according to one or more embodiments of the disclosure;

FIG. 6 is a diagram illustrating control of operation of a peripheral device (when a registered peripheral device operates) according to one or more embodiments of the disclosure;

FIG. 7 is a diagram illustrating control of operation of a peripheral device (when an unregistered peripheral device operates) according to one or more embodiments of the disclosure;

FIG. 8 is a diagram illustrating control of operation of a peripheral device (when a peripheral device information list stored in an information processing device is used) according to one or more embodiments of the disclosure;

FIG. 9 is a diagram illustrating an example of data stored in a peripheral device information storage unit according to one or more embodiments of the disclosure;

FIG. 10 is a sequence diagram illustrating an example of processing of control of operation of a peripheral device according to one or more embodiments of the disclosure;

FIG. 11 is a sequence diagram illustrating another example of processing of control of operation of a peripheral device according to one or more embodiments of the disclosure;

FIG. 12 is a sequence diagram illustrating still another example of processing of control of operation of a peripheral device according to one or more embodiments of the disclosure; and

FIG. 13 is a diagram illustrating an example of screen displayed on an information processing device according to one or more embodiments of the disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present disclosure are described below with reference to the attached drawings. In the specification and the drawings, components having substantially the same function and configuration are denoted by the same reference numerals, and redundant description thereof will be omitted.

Terms:

The “peripheral device” is a device that is connected to an information processing apparatus such as a personal computer via a universal serial bus (USB), a wireless local area network (LAN), or the like to be used. For example, the peripheral device may be, but is not limited to, a capture device, a camera, a microphone, a speaker, etc. The “capture device” is hardware for acquiring an image output from a High-Definition Multimedia Interface (HDMI) terminal or the like. For example, an information processing device such as a personal computer may cause a screen displayed on another personal computer (that is, a video signal received from another personal computer) to be shared between attendees (participants) of a video conference via a capture device.

Overview of Information Processing System:

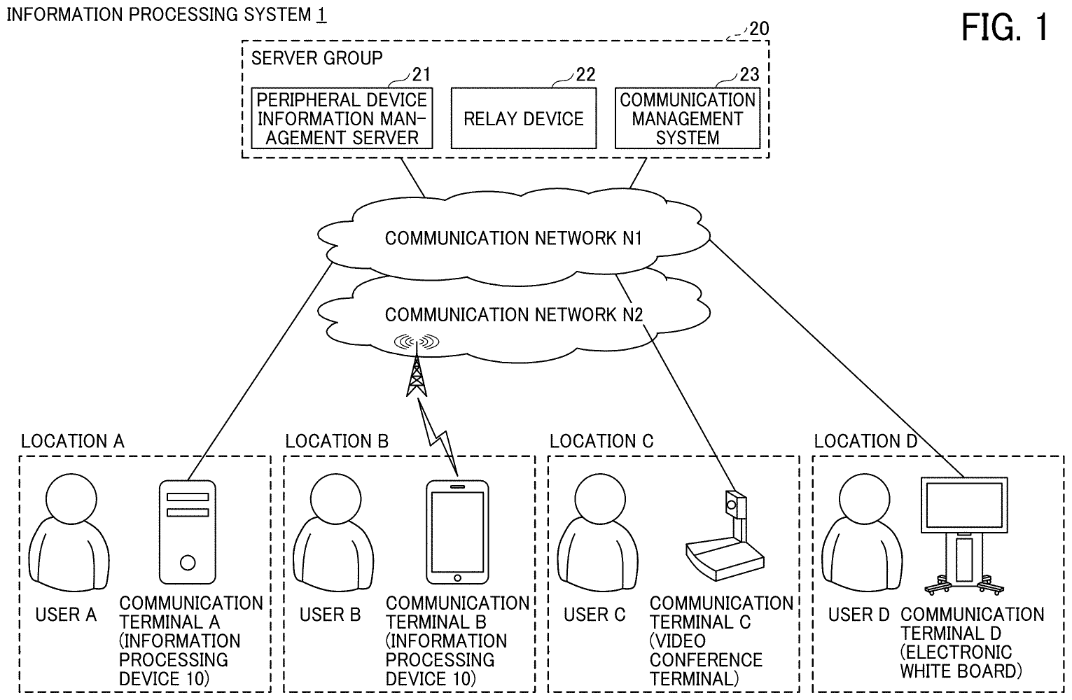

FIG. 1 is a schematic diagram illustrating an overview of an information processing system 1 according to an embodiment of the disclosure. For example, the information processing system 1 is a system for performing a video conference (also referred to as an online meeting) by bidirectional communication of images and sounds between a plurality of communication terminals. Irrespective of a type of conference (what is discussed in a meeting), the information processing system 1 is applicable.

As illustrated in FIG. 1, the information processing system 1 includes the plurality of communication terminals and a peripheral device information management server 21. As illustrated in FIG. 1, the information processing system 1 may further include a relay device 22 and a communication management system 23. The peripheral device information management server 21, the relay device 22, and the communication management system 23 are collectively referred to as a server group 20.

In the example of FIG. 1, a communication terminal A (an information processing device 10 placed at a location (base) A and operated (used) by a user A), a communication terminal B (another information processing device 10 placed at a location B and operated by a user B), a communication terminal C (a video conference terminal placed at a location C and operated by a user C), and a communication terminal D (an electronic whiteboard placed at a location D and operated by a user D) participate in a conference. A program according to one or more embodiments of the present disclosure is an application program installed on the information processing device 10 (in the example of FIG. 1, the communication terminal A or the communication terminal B). An information processing device according to one or more embodiments of the present disclosure is the information processing device 10 (the communication terminal A or the communication terminal B in the example of FIG. 1).

The communication terminals A, C, and D and the server group 20 are connected to a communication network N1 including the Internet. The communication network N1 may include a wireless communication network. The communication terminal B is connected to a communication network N2 via the communication network N1 such as a base station or a mobile communication network. By using the communication network N1 or N2, the communication terminals A, B, C, and D and the server group 20 communicates with each other.

The devices, apparatuses, or terminals described in the present embodiment are merely one example of a plurality of computing environments each for implementing an embodiment of the disclosure. In some embodiments, the peripheral device information management server 21 includes multiple computing devices, such as a server cluster. The plurality of computing devices communicate with one another through any type of communication link including a network, shared memory, etc., and performs a process described in the embodiment.

The information processing device 10 may be any device to which a peripheral device is connected, and is, for example, a personal computer. In addition, the information processing device 10 includes, for example, an output device such as a Projector (PJ), an Interactive White Board (a white board having an electronic whiteboard function capable of mutual communication (IWB)), and a digital signage, a Head Up Display (HUD) device, an industrial machine, an imaging device, a sound collecting device, a medical device, a network home appliance, an automobile (connected car), a notebook Personal Computer (PC), a mobile phone, a smartphone, a tablet terminal, a game console, a Personal Digital Assistant (PDA), a digital camera, a wearable PC or a desktop PC.

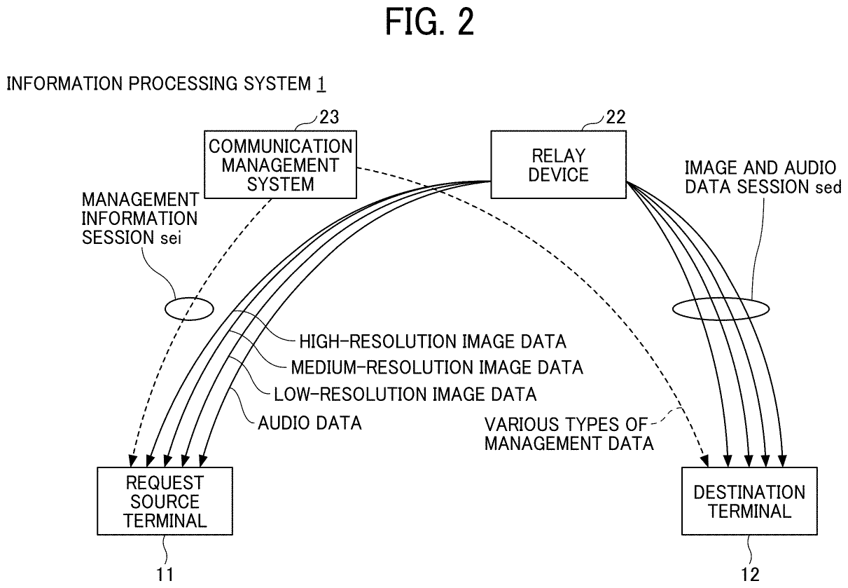

FIG. 2 is a diagram illustrating how a communication in a video conference is established according to an embodiment of the present disclosure. As described above, the information processing system 1 includes the plurality of communication terminals, the relay device 22, and the communication management system 23. Each communication terminal transmits or receives image data and audio data as an example of content data. The image data may be a video image or a still image, or both of the video image and the still image.

In the example of FIG. 2, one of the plurality of communication terminals that transmits a request for starting video conference is referred to as a “request source terminal 11”, and another one of the plurality of communication terminals that is a request transmission destination (relay destination) of the request is referred to as a “destination terminal 12”. The plurality of communication terminals may be used for a communication established between different offices or different rooms in the same office. In addition, the plurality of communication terminals may be used for a communication established in the same room, between outside of a building and inside of the building, or between different locations outside, for example.

The relay device 22 relays the content data between the plurality of communication terminals. The communication management system 23 centrally manages login authentication of each communication terminal, a communication status of each communication terminal, a destination list, and a communication status of the relay device 22. The relay devices 22 and the communication management system 23 may be configured by a single computer or a plurality of computers to which divided portions (functions) are arbitrarily allocated.

In the information processing system 1, the request source terminal 11 and the destination terminal 12 establishes a management information session sei with which various types of management information is transmitted by one to the other or received by one from the other via the communication management system 23. In addition, between the request source terminal 11 and the destination terminal 12, four sessions are established via the relay device 22. Each of the four sessions is a session for data transmission and data reception corresponding to one of four types of data including high-resolution image data, medium-resolution image data, low-resolution image data, and audio data. In FIG. 2, the four sessions are collectively illustrated as an image and audio data session sed. The image and audio data session sed does not necessarily to have the four sessions. The image and audio data session sed may have a smaller or larger number of sessions than the four sessions.

A description is now given of resolution of an image, which is used in the present embodiment. The low-resolution image data has, for example, 160 pixels in a horizontal direction and 120 pixels in a vertical direction. The low-resolution image data is to represent a base image. The medium-resolution image data has, for example, 320 pixels in the horizontal direction and 240 pixels in the vertical direction. The high-resolution image data has, for example, 640 pixels in the horizontal direction and 480 pixels in the vertical direction. In the case of a narrow band path, low-quality image data that only includes the low-resolution image data, which is serving as a base image, is relayed. In the case of a relatively wide band path, medium-quality image data including the low-resolution image data serving as a base image and the medium-resolution image data is relayed. In the case of a very wide band path, high-quality image data including the low-resolution image data serving as a base image, the medium-resolution image data, and the high-resolution image data is relayed. The audio data that has a data size smaller than the image data is relayed even in the case of a narrow band path.

Configuration of Information Processing Device and Peripheral Device:

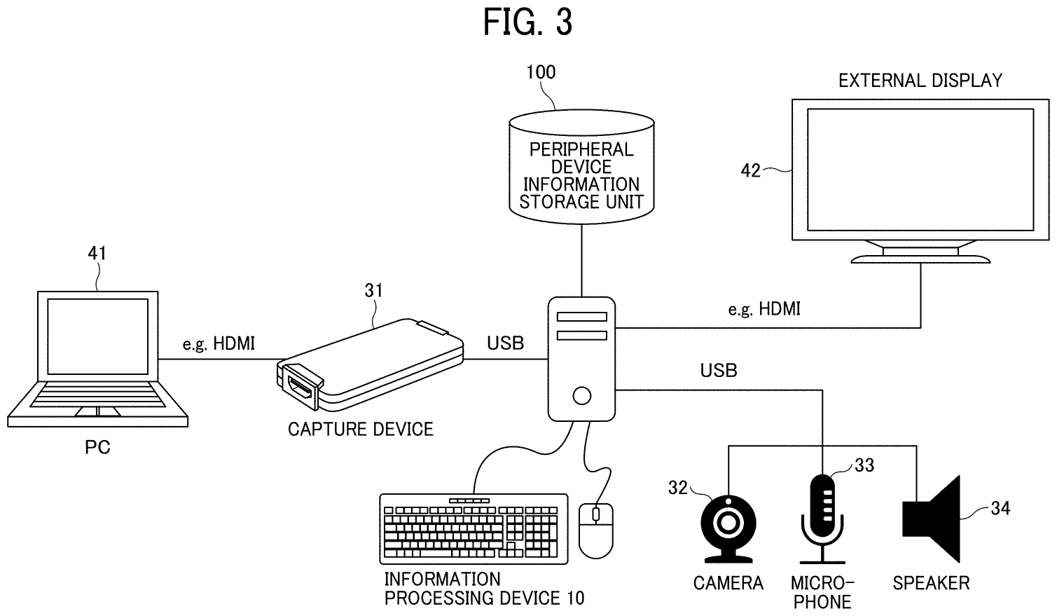

FIG. 3 is a diagram illustrating a configuration of the information processing device 10 and peripheral devices according to the present embodiment of the disclosure. As illustrated in FIG. 3, several peripheral devices are connected to the information processing device 10. In the example of FIG. 3, the peripheral devices such as a capture device 31, a camera 32, a microphone 33 and a speaker 34 are connected to the information processing device 10. The capture device 31 is connected to the information processing device 10 via a USB. The information processing device 10 is capable of making a screen that is being displayed on a PC 41, namely image signals received from the PC 41, be shared by using the capture device 31. Further, an external display 42 may be connected to the information processing device 10 through a High-Definition Multimedia Interface (HDMI), for example. In the present embodiment, the information processing device 10 controls the peripheral device connected to the information processing device 10 based on information on operation of each peripheral device stored in the peripheral device information storage unit 100.

Hardware Configuration:

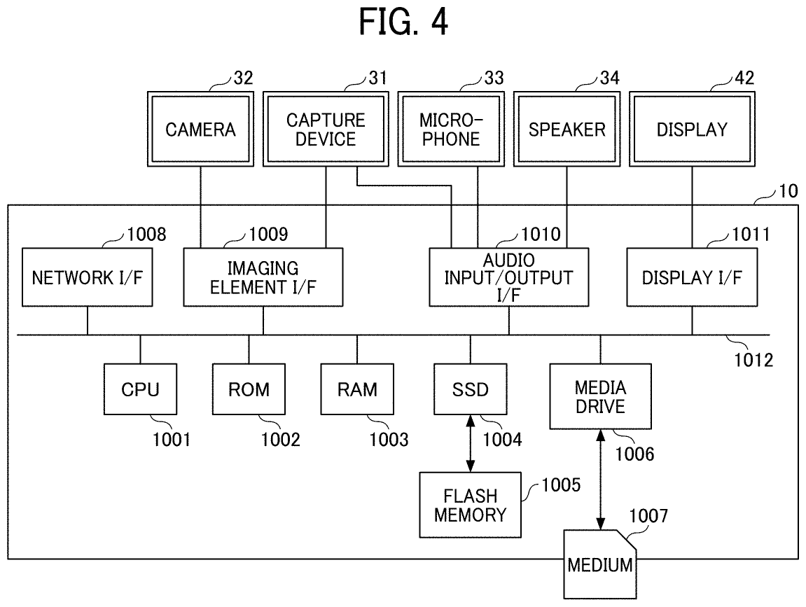

FIG. 4 is a block diagram illustrating a hardware configuration of the information processing device 10 according to the present embodiment of the disclosure. The same applies to the server group 20.

As illustrated in FIG. 4, the information processing device 10 is implemented by a computer, and includes a central processing unit (CPU) 1001, a read only memory (ROM) 1002, a random access memory (RAM) 1003, a Solid State Drive (SSD) 1004, a media drive 1006, a network interface (I/F) 1008, an imaging element I/F 1009, an audio input/output I/F 1010, and a display I/F 1011.

The CPU 1001 controls the entire operation of the information processing device 10. The ROM 1002 stores a program used for driving the CPU 1001 such as an Initial Program Loader (IPL). The RAM 1003 is used as a work area for the CPU 1001. A flash memory 1005 stores various data such as a communication control program, image data, and audio data. The SSD 1004 reads or writes various data from or to the flash memory 1005 under control of the CPU 1001. A Hard Disk Drive (HDD) may be used in alternative to the SSD 1004. The media drive 1006 reads or writes (stores) data from or to a recording medium 1007 such as a flash memory. The flash memory 1005 is replaceable with any suitable memory, such as an electrically erasable and programmable ROM (EEPROM), as long as the memory is a non-volatile memory that reads or writes data under control of CPU 1001. The recording medium 1007 is removable from the information processing device 10. The network I/F 1008 is an interface for performing data communication using a communication network such as the Internet. A bus line 1012 is, for example, an address bus or a data bus, which electrically connects the components illustrated in FIG. 4, such as the CPU 1001.

As described above, peripheral devices such as the capture device 31, the external camera 32, the external microphone 33, and the external speaker 34 are connectable to the information processing device 10 via a USB cable or the like. When the capture device 31 is connected to the information processing device 10, the capture device 31 is driven under control of the CPU 1001. Similarly, when the external camera 32, the external microphone 33, or the external speaker is connected to the information processing device 10, the external camera 32, the external microphone 33, or the external speaker 34 is driven under control of the CPU 1001.

The image sensor I/F 1009 is a circuit that controls driving of the capture device 31 or the camera 32. The audio input/output I/F 1010 is a circuit that processes input and output of audio signals between the microphone 33 and the speaker 34 under control of the CPU 1001. The display I/F 1011 is a circuit that transmits image data to the external display 42 under control of the CPU 1001.

The display 42 is an example of a display unit, such as a liquid crystal or organic Electroluminescence (EL) display that displays an image of object, an operation icon, and the like. The display 42 is connected to the display I/F 1011 by a cable. The cable may be an analog Red Green Blue (RGB) (Video Graphic Array (VGA)) signal cable, a component video cable, a HDMI signal cable, or a Digital Video Interactive (DVI) signal cable.

Functional Configuration:

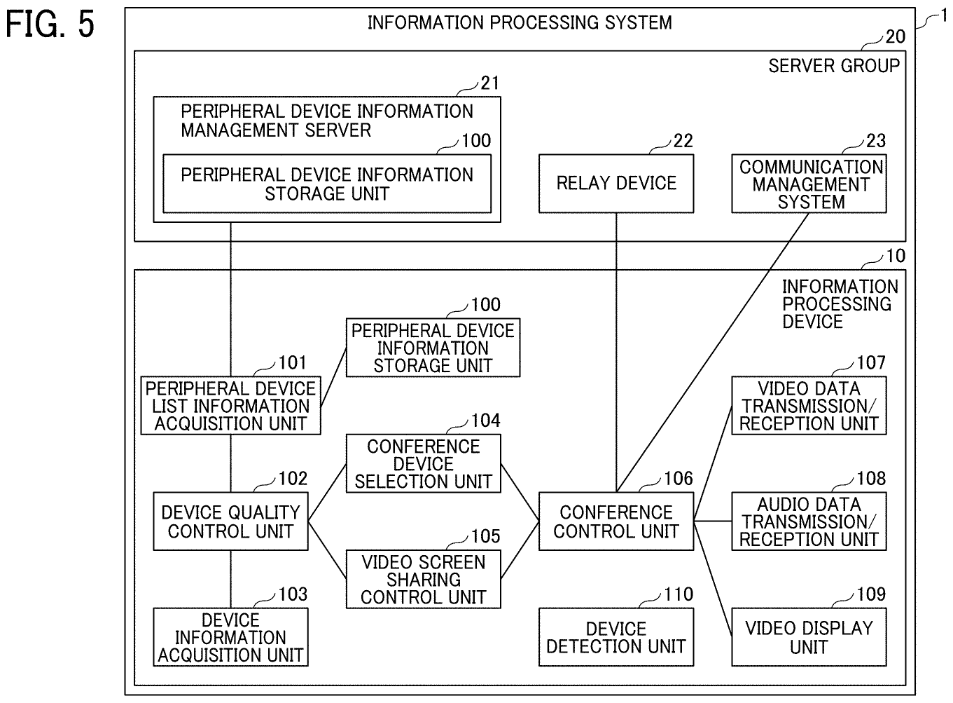

FIG. 5 is a block diagram illustrating a functional configuration of the information processing system 1 according to the present embodiment of the disclosure. The information processing device 10 includes, for example, a peripheral device list information acquisition unit 101, a device quality control unit 102, a device information acquisition unit 103, a conference device selection unit 104, a video screen sharing control unit 105, a conference control unit 106, a video data transmission/reception unit 107, an audio data transmission/reception unit 108, a video display unit 109, and a device detection unit 110. By executing a program, the information processing device 10 may implements the function of the peripheral device list information acquisition unit 101, the device quality control unit 102, the device information acquisition unit 103, the conference device selection unit 104, the video screen sharing control unit 105, the conference control unit 106, the video data transmission/reception unit 107, the audio data transmission/reception unit 108, the video display unit 109, and the device detection unit 110. At least one of the peripheral device information management server (also simply referred to as a “server”) 21 and the information processing device 10 may include a peripheral device information storage unit 100. Each of the functional units is described below.

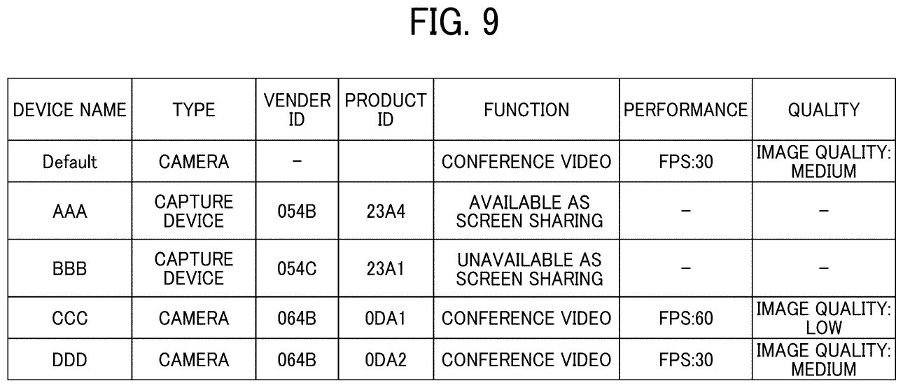

The peripheral device information storage unit 100 stores information on operation of one or more peripheral devices (a list in which information on the operation of each peripheral device is registered. Hereinafter, the information is also referred to as a peripheral device information list). The information (data) stored in the peripheral device information storage unit 100 is described later in detail with reference to FIG. 9.

The peripheral device information acquisition unit (also simply referred to as an “acquisition unit”) 101 acquires the information (peripheral device information list), which is related to the operation of the one or more peripheral devices, stored in the peripheral device information storage unit 100.

The device quality control unit (also simply referred to as “control unit”) 102 controls the operation of the one or more peripheral devices connected to the information processing device 10 in accordance with information on the operation of the one or more peripheral devices (peripheral device information list) stored in the peripheral device information storage unit 100.

Specifically, the device quality control unit 102 cause each of the one or more peripheral devices registered in the information on the operation of the one or more peripheral devices to operate based on at least one of function, performance, and quality registered in the information on the operation of the one or more peripheral devices. When a peripheral device connected to the information processing device 10 is not registered in the information on the operation of the one or more peripheral devices, the device quality control unit 102 causes the peripheral device connected to the information processing device 10 to operate based on at least one of a default value of the function, a default value of the performance, and a default value of the quality registered in the information on the operation of the one or more peripheral devices. When a peripheral device connected to the information processing device 10 is not registered in the information on the operation of the peripheral device, the device quality control unit 102 may cause the peripheral device connected to the information processing device 10 not to operate.

The device information acquisition unit 103 acquires information (specifically, a vendor ID and a product ID) on a peripheral device connected to the information processing device 10. The device quality control unit 102 compares the vendor ID and the product ID of the peripheral device connected to the information processing device 10 with the vendor ID and the product ID stored in the information on the operation of the one or more peripheral devices (peripheral device information list).

The conference device selection unit 104 does not switch a camera as a video conference camera to a capture device, when a peripheral device connected to the information processing device 10 is the capture device available (usable) as a screen sharing function. The conference device selection unit 104 switches a camera as a video conference camera to a capture device, when a peripheral device connected to the information processing device 10 is the capture device that is not available as a screen sharing function.

The video screen sharing control unit 105 starts screen sharing, when a capture device capable of performing screen sharing is connected. In addition, the video screen sharing control unit 105 does not start screen sharing when a capture device capable of performing screen sharing is not connected.

The conference control unit 106 controls the entire video conference.

The video data transmission/reception unit 107 transmits or receives video data to and from the relay device 22.

The audio data transmission/reception unit 108 transmits or receives audio data to or from the relay device 22.

The video display unit 109 performs control for transmitting image data to the display 42.

The device detection unit 110 detects peripheral devices (that is, devices such as a capture device, a camera, a microphone, and a speaker) connected to the information processing device 10.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

Overview:

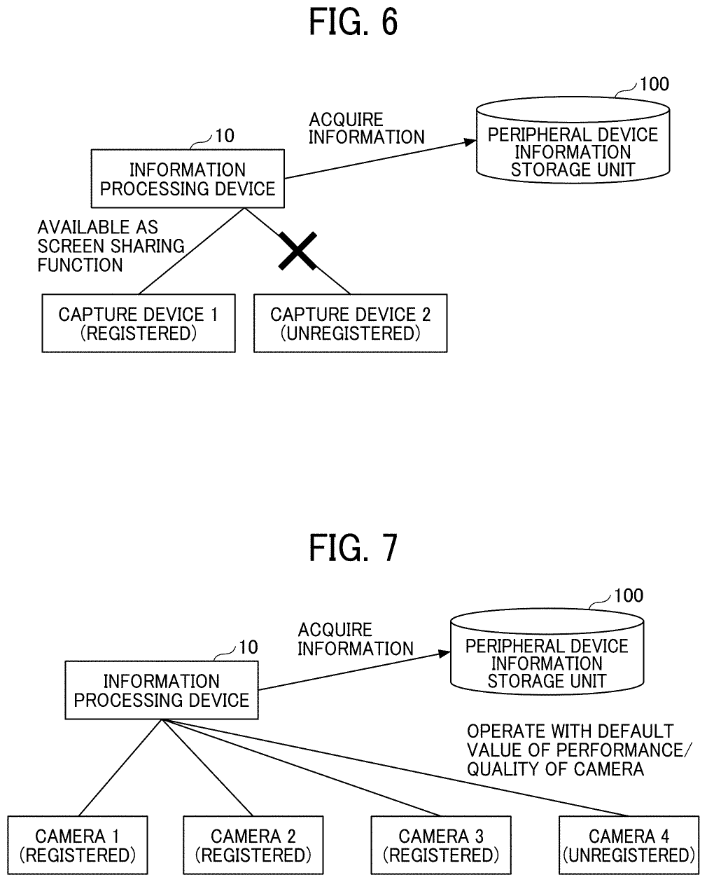

A description is given below of an overview of control of the operation of a peripheral device with reference to FIG. 6 to FIG. 8.

FIG. 6 is a diagram illustrating control of operation of a peripheral device, which is a registered peripheral device, according to one or more embodiments of the disclosure. The information processing device 10 is capable of causing the peripheral device (a capture device 1 in an example of FIG. 6) registered in the information on the operation of the one or more peripheral devices (peripheral device information list) in the peripheral device information storage unit 100 to operate with the corresponding function (the screen sharing function in the example of FIG. 6) registered in the information on the operation of the one or more peripheral devices (peripheral device information list) in the peripheral device information storage unit 100. In the example of FIG. 6, the information processing device 10 does not cause a peripheral device (a capture device 2 in the example of FIG. 6) that is not registered (unregistered) in the information on the operation of the one or more peripheral devices (peripheral device information list) in the peripheral device information storage unit 100.

FIG. 7 is a diagram illustrating control of operation of a peripheral device, which is an unregistered device, according to one or more embodiments of the disclosure. The information processing device 10 is capable of causing a peripheral device (a camera 4 in the example of FIG. 7) that is not registered in the information on the operation of the one or more peripheral devices (peripheral device information list) in the peripheral device information storage unit 100 using the default values of performance and quality registered in the information on the operation of the one or more peripheral devices (peripheral device information list) in the peripheral device information storage unit 100 (using the default values of the performance and quality of the camera in the example of FIG. 7).

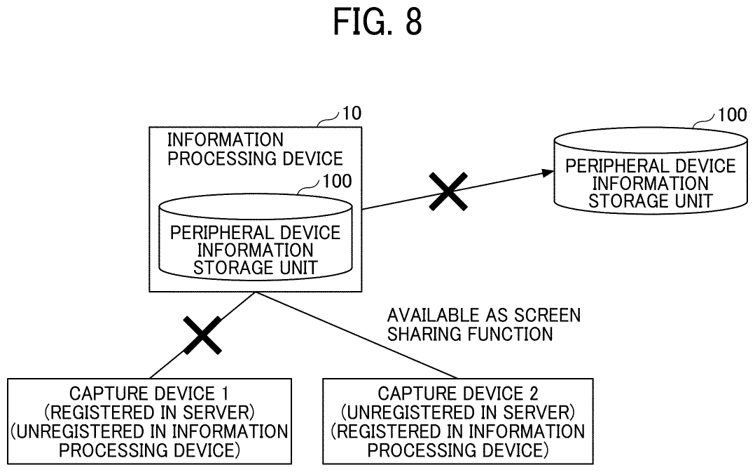

FIG. 8 is a diagram illustrating control of operation of a peripheral device by using a peripheral device information list stored in the information processing device 10, according to one or more embodiments of the disclosure; When the peripheral device information storage unit 100 is provided in each of the peripheral device information management server 21 and the information processing device 10, the information processing device 10 may controls the operation of the peripheral device according to the information on the operation of the one or more peripheral devices (peripheral device information list) stored in the peripheral device information storage unit 100 provided in the information processing device 10. In the example of FIG. 8, a capture device 1 that is registered in the peripheral device information management server 21, but not in the information processing device 10 is not to be used. On the other hand, a capture device 2 that is not registered in the peripheral device information management server 21 but is registered in the information processing device 10 is to be used as the screen sharing function.

Since the peripheral device information management server 21 includes the peripheral device information storage unit 100, it is possible to collectively perform setting on the peripheral device information management server 21, and thus it is not necessary to store information in each information processing device. In addition, since the information processing device 10 includes the peripheral device information storage unit 100, a peripheral device (or a function, performance, quality, or the like that is not set in the peripheral device information management server 21) that is not set in the peripheral device information management server 21 is available.

Data Structure:

FIG. 9 is a diagram illustrating an example of data stored in the peripheral device information storage unit 100 according to one or more embodiments of the disclosure. Specifically, the peripheral device information storage unit 100 stores information on the operation of the one or more peripheral devices (peripheral device information list).

As illustrated in FIG. 9, the information on the operation of the one or more peripheral devices (peripheral device information list) includes data items of “device name”, “type”, “vendor ID”, “product ID”, “function”, “performance”, “quality”, for example. Each of the data items is described below.

The “device name” indicates a name of a peripheral device.

The “type” indicates a type of a peripheral device. For example, as the type, capture device, camera, microphone, speaker, or the like is indicated.

The “vendor ID” indicates an identifier of a manufacturer of a peripheral device. In one of more embodiments of the present disclosure, the operation of a peripheral device may be controlled for each vendor (manufacturer of the peripheral device).

The “product ID” indicates an identifier of a peripheral device. In one of more embodiments of the present disclosure, the operation of a peripheral device may be controlled for each peripheral device.

The information processing device 10 compares the vendor ID and the product ID of a peripheral device connected to the information processing device 10 with the vendor ID and the product ID stored in the information on the operation of the one or more peripheral devices (peripheral device information list).

The “function” indicates a function of a peripheral device in operating and whether the peripheral device is able to operate as the function. For example, as the function, conference video, available as screen sharing, unavailable as screen sharing, or the like is indicated.

The “performance” indicates performance of the peripheral device in operating. For example, the performance is a frame rate (FPS) or the like. The “quality” indicates the quality of the peripheral device in operating. For example, as the quality, image quality (high, medium, low, etc.) or the like is used. Examples of “performance” and “quality” are merely examples, and may be resolution, a sampling frequency, the number of channels, or the like.

As illustrated in FIG. 9, the peripheral device information storage unit 100 stores, for each peripheral device, the data items of “device name”, “type”, “vendor ID”, “product ID”, “function”, “performance”, and “quality”, for example. Furthermore, the peripheral device information storage unit 100 stores a function default value, a performance default value, and a quality default value for each type (capture device, camera, microphone, speaker, etc.).

Processing:

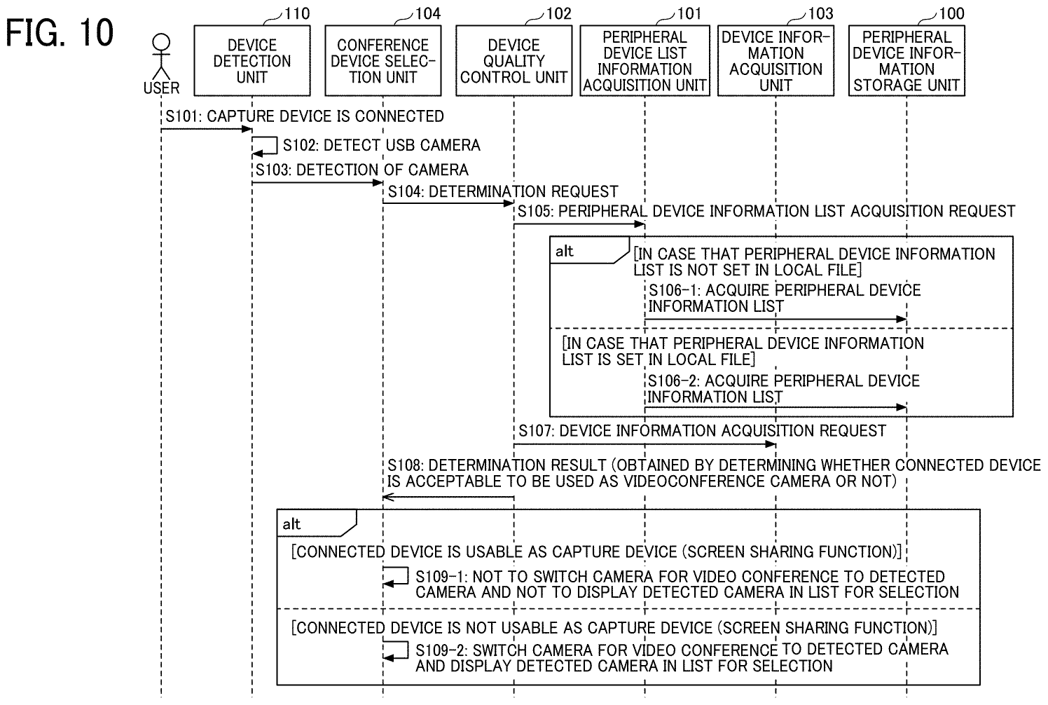

FIG. 10 is a sequence diagram illustrating an example of processing of control of operation of a peripheral device according to one or more embodiments of the present disclosure.

In step 101 (S101), a capture device is connected to the information processing device 10 by a user, for example.

In step 102 (S102), the device detection unit 110 detects the capture device, which is connected to the information processing device 10 in S101, as a USB-camera. The USB-camera is a camera that is connected to the information processing device 10 by using a USB.

In step 103 (S103), the device detection unit 110 notifies the conference device selection unit 104 that a connection of the camera is detected in S102.

In step 104 (S104), the conference device selection unit 104 requests the device quality control unit 102 to determine whether the camera notified in S103 is available (usable) or not.

In step 105 (S105), the device quality control unit 102 requests the peripheral device list information acquisition unit 101 to acquire the peripheral device information list (that is, the information on the operation of the one or more peripheral devices). Such a request for the peripheral device information list may be referred to as a peripheral device information list acquisition request in the description of the present embodiment.

In step 106 (S106), the peripheral device list information acquisition unit 101 acquires the peripheral device information list (namely, information on the operation of the one or more peripheral devices) stored in the peripheral device information storage unit 100. When the peripheral device information list is not set in a local file of the information processing device 10, the peripheral device list information acquisition unit 101 acquires the peripheral device information list from the peripheral device information management server 21 (S106-1 in FIG. 10). On the other hand, when the peripheral device information list is set in the local file of the information processing device 10, the peripheral device list information acquisition unit 101 acquires the peripheral device information list, which is set in the local file (S106-2 in FIG. 10).

The information processing device 10 may acquire the peripheral device information list (namely, information on the operation of the one or more peripheral devices) from the peripheral device information management server 21 and store the peripheral device information list in a local memory, for later use, at a time of starting an application program according to an embodiment of the present disclosure. Alternatively, the information processing device 10 may sequentially acquire the peripheral device information list.

In step 107 (S107), the device quality control unit 102 requests the device information acquisition unit 103 to acquire information on the device being connected (namely, the capture device detected in S101). The information on the device includes, for example, a vendor ID and a product ID of the connected device. Such a request for the information on the device may be referred to as a device information acquisition request, in the description of the embodiment.

In step 108 (S108), the device quality control unit 102 notifies the conference device selection unit 104 of a result. For example, when the connected device, which is namely the capture device detected in S101, is registered as an unauthorized (unacceptable/unavailable) device to be used as a camera for a video conference in the peripheral device information list, which is namely the information on the operation of the one or more peripheral devices, the device quality control unit 102 determines that the device is not acceptable to be used as the camera. On the other hand, when the connected device, which is namely the capture device detected in S101, is not registered as an unauthorized device to be used as a camera for a video conference in the peripheral device information list, which is namely the information on the operation of the one or more peripheral devices, the device quality control unit 102 determines that the device is acceptable to be used as the camera.

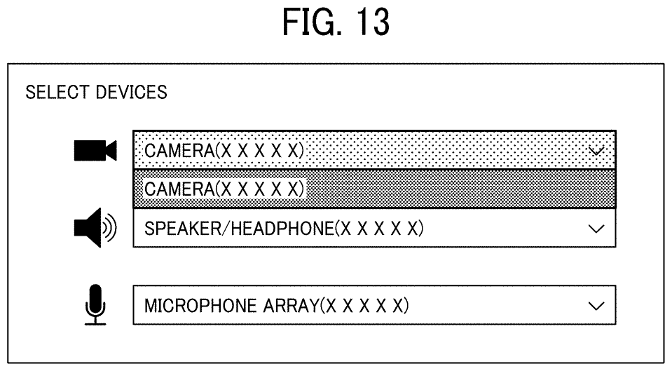

In step 109 (S109), when the connected device, which is namely the capture device detected in S101, is a capture device that is available as a screen sharing function, the conference device selection unit 104 does not switch a camera for the video conference to the detected camera. In addition, the detected camera is not displayed on a setting screen (which is to be described with reference to FIG. 13) for the user to select a device such as a camera, a speaker, or a microphone to be used in the video conference (S109-1 in FIG. 10). On the other hand, when the connected device, which is namely the capture device detected in S101, is a capture device that is not available as a screen sharing function, the conference device selection unit 104 switches a camera for the video conference to the detected camera. In addition, the detected camera is displayed on the setting screen (which is to be described with reference to FIG. 13) for the user to select a device such as a camera, a speaker, or a microphone to be used in the video conference (S109-2 in FIG. 10).

As described above, the information processing device 10, such as a PC, detects a USB capture device (a capture device connected to the information processing device 10 by using a USB) as a USB camera (a camera connected to the information processing device 10 by using a USB) and a USB microphone (a microphone connected to the information processing device 10 by using a USB). In one or more embodiments of the present disclosure, a capture device whose “function” is registered as “available as screen sharing” in the information on the operation of the one or more peripheral devices (peripheral device information list) stored in the peripheral device information storage unit 100 does not operate as a camera or a microphone. Accordingly, the capture device whose “function” is registered as “available as screen sharing” is not automatically switched to the camera or the microphone for the video conference. In addition, a capture device whose “function” is registered as “available as screen sharing” is not displayed as an option of a camera or a microphone on the setting screen as illustrated in FIG. 13.

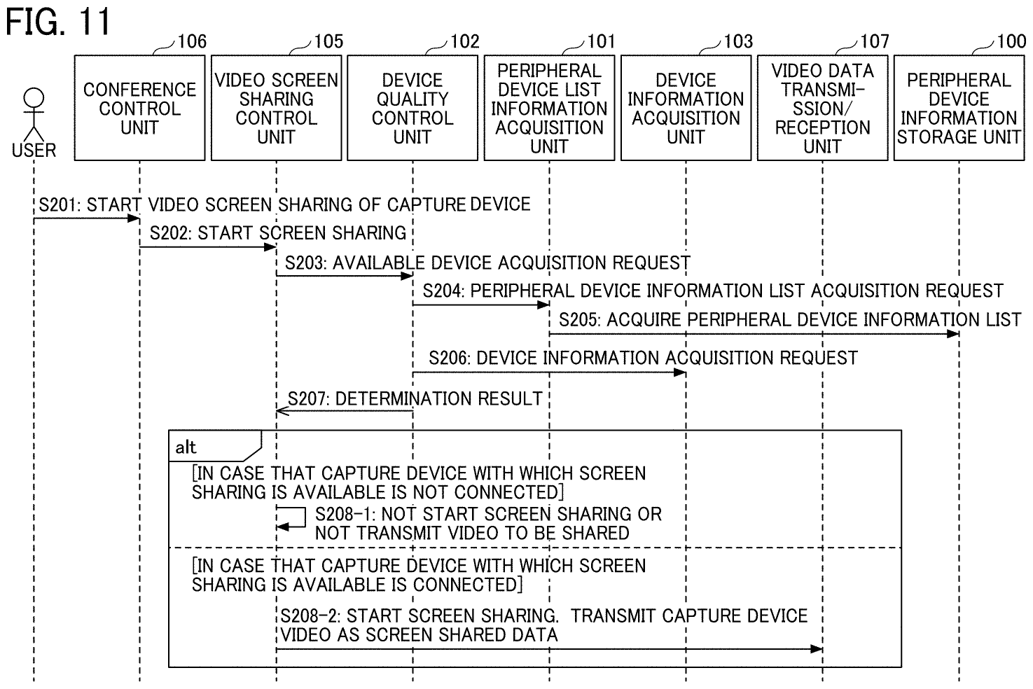

FIG. 11 is a sequence diagram illustrating another example of processing of control of operation of a peripheral device according to one or more embodiments of the disclosure.

In step 201 (S201), a user starts screen sharing of a video of a capture device (that is, a screen being displayed on the PC 41), for example. Hereinafter, the screen sharing of a video may be referred to as video screen sharing in the description of the embodiment.

In step 202 (S202), the conference control unit 106 requests the video screen sharing control unit 105 to start sharing a screen.

In step 203 (S203), the video screen sharing control unit 105 requests the device quality control unit 102 to acquire available devices.

In step 204 (S204), the device quality control unit 102 requests the peripheral device list information acquisition unit 101 to acquire the peripheral device information list (namely, the information on the operation of the one or more peripheral devices). Such a request for the peripheral device information list may be referred to as a peripheral device information list acquisition request in the description of the embodiment.

In step 205 (S205), the peripheral device list information acquisition unit 101 acquires the peripheral device information list (namely, the information on the operation of the one or more peripheral devices) stored in the peripheral device information storage unit 100.

In step 206 (S206), the device quality control unit 102 requests the device information acquisition unit 103 to acquire information on the device being connected (namely, the capture device in S201). The information on the device includes, for example, a vendor ID and a product ID of the connected device. Such a request for information on the device may be referred to as a device information acquisition request, in the description of the embodiment.

In step 207 (S207), the device quality control unit 102 notifies the video screen sharing control unit 105 of a result.

In step 208 (S208), when the capture device unavailable as a screen sharing function is connected, the video screen sharing control unit 105 does not start screen sharing or does not transmit the video for screen sharing (S208-1 in FIG. 11). On the other hand, when the capture device available as a screen sharing function is connected, the video screen sharing control unit 105 starts screen sharing (the video screen sharing control unit 105 transmits the video data of the capture devices to the video data transmission/reception unit 107 as screen shared data (S208-2 in FIG. 11)).

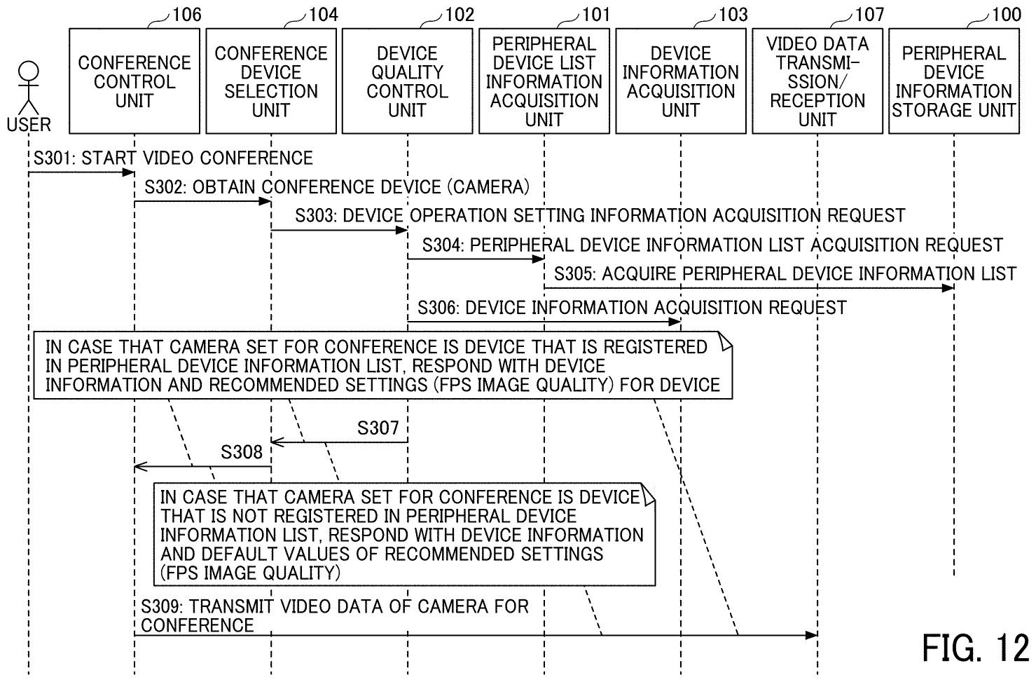

FIG. 12 is a sequence diagram illustrating still another example of processing of control of operation of a peripheral device according to one or more embodiments of the disclosure.

In step 301 (S301), a video conference is started by a user, for example.

In step 302 (S302), the conference control unit 106 requests the conference device selection unit 104 to obtain devices (for example, a camera or the like) for the video conference.

In step 303 (S303), the conference device selection unit 104 requests the device quality control unit 102 to acquire information on the settings in relation to the operation of the devices.

In step 304 (S304), the device quality control unit 102 requests the peripheral device list information acquisition unit 101 to acquire the peripheral device information list (namely, the information on the operation of the one or more peripheral devices). Such a request for the peripheral device information list may be referred to as a peripheral device information list acquisition request in the description of the embodiment.

In step 305 (S305), the peripheral device list information acquisition unit 101 acquires the peripheral device information list (namely, the information on the operation of the one or more peripheral devices) stored in the peripheral device information storage unit 100.

In step 306 (S306), the device quality control unit 102 requests the device information acquisition unit 103 to acquire information on the device being connected. The information on the device includes, for example, a vendor ID and a product ID of the connected device. Such a request for information on the device may be referred to as a device information acquisition request, in the description of the embodiment.

In step 307 (S307), the device quality control unit 102 notifies the conference device selection unit 104 of a result. When the camera that is set for the video conference is registered in the peripheral device information list, the result includes the performance and the quality (FPS, image quality, and the like) of the peripheral device. On the other hand, when the camera that is set for the video conference is not registered in the peripheral device information list, the result includes default values of the performance and the quality (FPS, image quality, and the like).

In step 308 (S308), the conference device selection unit 104 notifies the conference control unit 106 of the result.

In step 309 (S309), the conference control unit 106 transmits video of the camera for the video conference to the video data transmission/reception unit 107. When the camera that is set for the video conference is registered in the peripheral device information list, the performance and the quality (FPS, image quality, and the like) of the peripheral device are used. On the other hand, when the camera that is set for the video conference is not registered in the peripheral device information list, the default values of the performance and the quality (FPS, image quality, and the like) are used.

User Interface:

FIG. 13 is an example of a screen displayed on the information processing device 10 according to one or more embodiments of the present disclosure. Specifically, FIG. 13 is a setting screen for a user to select a device such as a camera, a speaker, or a microphone to be used in a video conference.

As described above, the information processing device 10, such as a PC, detects a USB capture device (a capture device connected to the information processing device 10 by using a USB) as a USB camera (a camera connected to the information processing device 10 by using a USB) and a USB microphone (a microphone connected to the information processing device 10 by using a USB).

In one or more embodiments of the present disclosure, a capture device whose “function” is registered as “available as screen sharing” in the information on the operation of the one or more peripheral devices (peripheral device information list) stored in the peripheral device information storage unit 100 does not operate as a camera or a microphone. Accordingly, a capture device whose “function” is registered as “available as screen sharing” is not displayed as an option of a camera or a microphone on the setting screen as illustrated in FIG. 13. This prevents the user from erroneously selecting the capture device as a camera or a microphone.

As described above, according to the above described embodiments, the operation of the peripheral device connected to the information processing device is controllable. For example, when a capture device that is registered as a device available as a screen sharing function is connected to an information processing device, the information processing device uses the capture device as the screen sharing function (that is, the capture device is not used as a camera or a microphone). In addition, for example, the information processing device is capable of causing a peripheral device such as a camera to operate with the performance and the quality registered in advance, resulting in reducing the load of the entire video conference system.

According to one of the embodiments, a method performed by the information processing device is provided. The method includes acquiring the information on the operation of the one or more peripheral devices, and causing a peripheral device connected to the information processing device to operate according to the information on the operation of the one or more peripheral devices.

In a conventional technique, whether a USB device being connected is available or not is determined, however how the USB device cooperates with a peripheral device is not determined. For example, with what kind of function, performance, quality or the like the peripheral device operates is not determined, and the operation of the peripheral device is not controlled.

According to one or more embodiments of the present disclosure, operation of a peripheral device is controllable.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

1. A non-transitory recording medium storing a plurality of instructions which, when executed by one or more processors, causes the processors to perform a method, the method comprising:
acquiring information on operation of one or more peripheral devices connectable to an information processing device; and
causing a peripheral device being connected to the information processing device to operate according to the information on the operation of the one or more peripheral devices.

2. The non-transitory recording medium of claim 1,
wherein, in case that the peripheral device being connected to the information processing device is registered as one of the one or more peripheral devices in the information, the causing the peripheral device to operate includes causing the peripheral device to operate based on at least one of a function, performance, and quality registered in the information.

3. The non-transitory recording medium of claim 1,
wherein, in case that the peripheral device being connected to the information processing device is unregistered in the information, the causing the peripheral device to operate includes causing the peripheral device to operate based on at least one of default values for a function, performance, and quality registered in the information.

4. The non-transitory recording medium of claim 1,
wherein, in case that the peripheral device being connected to the information processing device is unregistered in the information, the causing the peripheral device to operate is canceled.

5. The non-transitory recording medium of claim 1,
wherein the acquiring the information includes acquiring the information from a memory of a server.

6. The non-transitory recording medium of claim 1,
wherein the acquiring the information includes acquiring the information from a memory of the information processing device.

7. The non-transitory recording medium of claim 1,
wherein, in case that the information is stored in each of a first memory of a server and a second memory of the information processing device, the causing the peripheral device to operate includes causing the peripheral device to operate according to the information stored in the second memory of the information processing device.

8. An information processing device, comprising
circuitry configured to
acquire information on operation of one or more peripheral devices, and
cause a peripheral device being connected to the information processing device to operate according to the information.

9. The information processing device of claim 8,
wherein in case that the peripheral device being connected to the information processing device is registered as one of the one or more peripheral devices in the information, the circuitry causes the peripheral device to operate based on at least one of a function, performance, and quality registered in the information.

10. The information processing device of claim 8,
wherein, in case that the peripheral device being connected to the information processing device is unregistered in the information, the circuitry causes the peripheral device to operate based on at least one of default values for a function, performance, and quality registered in the information.

11. The information processing device of claim 8,
wherein, in case that the peripheral device being connected to the information processing device is unregistered in the information, the circuitry cancels causing the peripheral device to operate.

12. The information processing device of claim 8,
wherein the circuitry acquires, from a memory of a server, the information.

13. The information processing device of claim 8,
wherein the circuitry acquires, from a memory of the information processing device, the information.

14. The information processing device of claim 8,
wherein, in case that the information is stored in each of a first memory of a server and a second memory of the information processing device, the circuitry causes the peripheral device to operate according to the information stored in the second memory of the information processing device.

15. An information processing system, comprising:
an information processing device; and
a server communicably connected to the information processing device and including a memory that stores information on operation of one or more peripheral devices,
the information processing device including circuitry configured to
acquire, from the server, the information on the operation of the one or more peripheral devices, and
cause a peripheral device being connected to the information processing device to operate according to the acquired information.
